(19) United States
(12) Patent Application Publication
(10) Pub. No.: US 2024/0192507 A1
(43) Pub. Date: Jun. 13, 2024

(54) Display Systems With Strain Gauge Circuitry

(71) Applicant: Apple Inc., Cupertino, CA (US)

(72) Inventors: Christopher Patton, San Jose, CA (US); Michael J Oudenhoven, San Francisco, CA (US); Rick Y Huang, Sunnyvale, CA (US)

(21) Appl. No.: 18/444,869

(22) Filed: Feb. 19, 2024

Related U.S. Application Data
(63) Continuation of application No. PCT/US22/42641, filed on Sep. 6, 2022.
(60) Provisional application No. 63/285,419, filed on Dec. 2, 2021.
(60) Provisional application No. 63/246,603, filed on Sep. 21, 2021.

(51) Int. Cl. G02B 27/01; G01B 7/16

(52) U.S. Cl. CPC G02B 27/0176; G01B 7/18; G02B 27/0172; G02B 2027/0178

(57) ABSTRACT

A head-mounted device may have a head-mounted frame. The head-mounted frame may have an internal frame member such as a metal frame member (metal frame structure). Frame structures such as polymer frame structures may be molded over the internal frame member and may be provided with lens openings. The head-mounted device may have lenses with waveguides that are mounted in the lens openings. The waveguides may be used in guiding images received from projectors to eye boxes for viewing by a user. Strain gauge circuitry may be attached to a central portion of the internal frame member. During operation of the head-mounted device, the strain gauge circuitry may measure for deformation of the internal frame member, so that image warping operations may be performed or so that other actions may be taken to correct for image distortion arising from the measured deformation.

This application is a continuation of international patent application No. PCT/US2022/042641, filed Sep. 6, 2022, which claims priority to U.S. provisional patent application No. 63/285,419, filed Dec. 2, 2021, and U.S. provisional patent application No. 63/246,603, filed Sep. 21, 2021, which are hereby incorporated by reference herein in their entireties.

### FIELD

This relates generally to electronic devices, and, more particularly, to electronic devices such as head-mounted devices.

### BACKGROUND

Electronic devices such as head-mounted devices may have displays for displaying images. The displays may be housed in a head-mounted support structure.

### SUMMARY

A head-mounted device may have a head-mounted frame that serves as a housing for device components. The head-mounted frame may have an internal frame member such as a metal frame member. The metal frame member, which may sometimes be referred to as a metal frame structure, metal frame portion, metal internal frame, etc., may have a top portion that extends laterally across the top of the head-mounted frame. The metal frame member may also have side portions that extend downwardly from respective left and right end portions of the top portion of the metal frame member. A central region of the top portion of the metal frame member that lies between the left and right end portions or other region of the metal frame member may be provided with planar surfaces and a rectangular cross-sectional profile. This central portion of the metal frame member may be thicker in one or more dimensions than the end portions of the top portion of the metal frame member or may be thinner in one or more dimensions than the end portions of the top portion of the metal frame member.

Frame structures such as polymer frame structures may be molded over the internal frame member and may be provided with lens openings. The head-mounted device may have lenses with waveguides that are mounted in the lens openings. The waveguides may be used in guiding images received from projectors to eye boxes for viewing by a user.

Strain gauge circuitry, which may sometimes be referred to as a strain gauge, may be attached to the top portion of the internal frame member in the central region or other region of the internal frame member. During operation of the head-mounted device, the strain gauge circuitry may measure for deformation of the internal frame member. This allows image warping operations may be performed or other actions may be taken to correct for image distortion in the images that arises from the measured deformation. The strain gauge circuitry may be embedded within a protective polymer structure. When the polymer frame structures are molded over the internal frame member, the protective polymer structure may prevent polymer in the polymer frame structures from contacting the strain gauge circuitry.

### BRIEF DESCRIPTION OF THE DRAWINGS

FIG. 1 is a schematic diagram of an illustrative electronic device such as a head-mounted display device in accordance with an embodiment.

FIG. 2 is a top view of an illustrative head-mounted device in accordance with an embodiment.

FIG. 3 is a rear perspective view of the underside of a head-mounted device in accordance with an embodiment.

FIG. 4 is a diagram of illustrative circuitry for a head-mounted device in accordance with an embodiment.

FIG. 5 is a diagram of an illustrative internal frame member for a head-mounted device in accordance with an embodiment.

FIG. 6 is a diagram of the illustrative frame member of FIG. 5 to which the illustrative circuitry of FIG. 4 has been mounted in accordance with an embodiment.

FIG. 7 is a diagram of a portion of a head-mounted device in accordance with an embodiment.

FIG. 8 is a perspective view of an illustrative frame member for a head-mounted device in accordance with an embodiment.

FIG. 9 is a cross-sectional side view of a central portion of the illustrative frame member of FIG. 8 to which a strain gauge has been mounted in accordance with an embodiment.

FIG. 10 is a perspective view of illustrative strain gauge circuitry for a head-mounted device in accordance with an embodiment.

FIG. 11 is a cross-sectional side view of a portion of an illustrative head-mounted support structure in accordance with an embodiment.

### DETAILED DESCRIPTION

Electronic devices such as head-mounted devices may include displays and other components for presenting content to users. A head-mounted device may have head-mounted support structures that allow the head-mounted device to be worn on a user's head. The head-mounted support structures may support optical components such as displays for displaying visual content and front-facing cameras for capturing real-world images. In an illustrative configuration, optical components such as waveguides may be used to provide images from display projectors to eye boxes for viewing by a user.

The head-mounted device may have sensors. For example, a strain gauge sensor may be used to monitor for potential deformation of the support structures (e.g., twisting, bending, etc.). Deformation of the support structures (e.g., deformation of a glasses frame member or other head-mounted support structure due to excessive force such as force from a drop event) may potentially lead to optical component misalignment and image distortion. By monitoring for frame bending and other support structure deformations using strain gauge sensor circuitry, corrective actions may be taken to prevent undesired image distortion. For example, digital image warping operations may be performed on digital image data being provided to the projectors and/or other actions may be taken to compensate for the deformation. In this way, the head-mounted device may compensate for the measured support structure deformation.

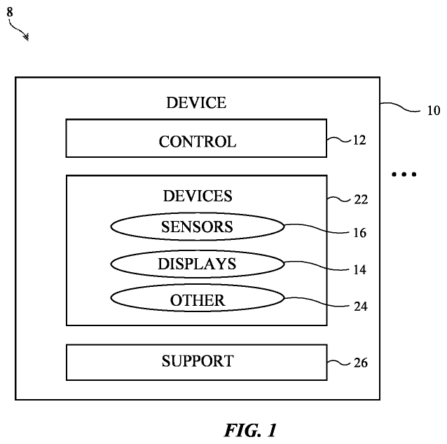

A schematic diagram of an illustrative system that may include a head-mounted device is shown in FIG. 1. As shown in FIG. 1, system 8 may include one or more electronic devices such as electronic device 10. The electronic devices of system 8 may include computers, cellular telephones, head-mounted devices, wristwatch devices, and other electronic devices. Configurations in which electronic device 10 is a head-mounted device are sometimes described herein as an example.

As shown in FIG. 1, electronic devices such as electronic device 10 may have control circuitry 12. Control circuitry 12 may include storage and processing circuitry for controlling the operation of device 10. Circuitry 12 may include storage such as hard disk drive storage, nonvolatile memory (e.g., electrically-programmable-read-only memory configured to form a solid-state drive), volatile memory (e.g., static or dynamic random-access-memory), etc. Processing circuitry in control circuitry 12 may be based on one or more microprocessors, microcontrollers, digital signal processors, baseband processors, power management units, audio chips, graphics processing units, application specific integrated circuits, and other integrated circuits. Software code may be stored on storage in circuitry 12 and run on processing circuitry in circuitry 12 to implement control operations for device 10 (e.g., data gathering operations, operations involving the adjustment of the components of device 10 using control signals, etc.). Control circuitry 12 may include wired and wireless communications circuitry. For example, control circuitry 12 may include radio-frequency transceiver circuitry such as cellular telephone transceiver circuitry, wireless local area network transceiver circuitry (e.g., WIFI® circuitry), millimeter wave transceiver circuitry, and/or other wireless communications circuitry.

During operation, the communications circuitry of the devices in system 8 (e.g., the communications circuitry of control circuitry 12 of device 10), may be used to support communication between the electronic devices. For example, one electronic device may transmit video data, audio data, and/or other data to another electronic device in system 8. Electronic devices in system 8 may use wired and/or wireless communications circuitry to communicate through one or more communications networks (e.g., the internet, local area networks, etc.). The communications circuitry may be used to allow data to be received by device 10 from external equipment (e.g., a tethered computer, a portable device such as a handheld device or laptop computer, online computing equipment such as a remote server or other remote computing equipment, or other electrical equipment) and/or to provide data to external equipment.

Device 10 may include input-output devices 22. Input-output devices 22 may be used to allow a user to provide device 10 with user input. Input-output devices 22 may also be used to gather information on the environment in which device 10 is operating. Output components in devices 22 may allow device 10 to provide a user with output and may be used to communicate with external electrical equipment.

As shown in FIG. 1, input-output devices 22 may include one or more displays such as displays 14. In some configurations, device 10 includes left and right display devices (e.g., left and right components such as left and right projectors based on scanning mirror display devices, liquid-crystal-on-silicon display devices, digital mirror devices, or other reflective display devices, left and right display panels based on light-emitting diode pixel arrays (e.g., organic light-emitting display panels or display devices based on pixel arrays formed from crystalline semiconductor light-emitting diode dies), liquid crystal display panels, and/or or other left and right display devices that provide images to left and right eye boxes for viewing by the user's left and right eyes, respectively. Illustrative configurations in which device 10 has left and right display devices such as left and right projectors that provide respective left and right images for a user's left and right eyes may sometimes be described herein as an example.

Displays 14 are used to display visual content for a user of device 10. The content that is presented on displays 14 may include virtual objects and other content that is provided to displays 14 by control circuitry 12. This virtual content may sometimes be referred to as computer-generated content. Computer-generated content may be displayed in the absence of real-world content or may be combined with real-world content. For example, an optical coupling system may be used to allow computer-generated content to be optically overlaid on top of a real-world image. In particular, device 10 may have a see-through display system that provides a computer-generated image to a user through a beam splitter, prism, holographic coupler, diffraction grating, or other optical coupler (e.g., an output coupler on a waveguide that is being used to provide computer-generated images to the user) while allowing the user to view real-world objects through the optical coupler and other transparent structures (e.g., transparent waveguide structures, vision-correction lenses and/or other lenses, etc.).

Input-output circuitry 22 may include sensors 16. Sensors 16 may include, for example, three-dimensional sensors (e.g., three-dimensional image sensors such as structured light sensors that emit beams of light and that use two-dimensional digital image sensors to gather image data for three-dimensional images from light spots that are produced when a target is illuminated by the beams of light, binocular three-dimensional image sensors that gather three-dimensional images using two or more cameras in a binocular imaging arrangement, three-dimensional lidar (light detection and ranging) sensors, three-dimensional radio-frequency sensors, or other sensors that gather three-dimensional image data), cameras (e.g., infrared and/or visible digital image sensors), gaze tracking sensors (e.g., a gaze tracking system based on an image sensor and, if desired, a light source that emits one or more beams of light that are tracked using the image sensor after reflecting from a user's eyes), touch sensors, capacitive proximity sensors, light-based (optical) proximity sensors, other proximity sensors, force sensors, sensors such as contact sensors based on switches, gas sensors, pressure sensors, moisture sensors, magnetic sensors, audio sensors (microphones), ambient light sensors, microphones for gathering voice commands and other audio input, sensors that are configured to gather information on motion, position, and/or orientation (e.g., accelerometers, gyroscopes, compasses, and/or inertial measurement units that include all of these sensors or a subset of one or two of these sensors), strain gauge sensors, and/or other sensors.

User input and other information may be gathered using sensors and other input devices in input-output devices 22. If desired, input-output devices 22 may include other devices 24 such as haptic output devices (e.g., vibrating components), light-emitting diodes and other light sources, speakers such as ear speakers for producing audio output, circuits for receiving wireless power, circuits for transmitting power wirelessly to other devices, batteries and other energy storage devices (e.g., capacitors), joysticks, buttons, and/or other components.

Electronic device 10 may have housing structures as shown by illustrative support structures 26 of FIG. 1. In configurations in which electronic device 10 is a head-mounted device (e.g., a pair of glasses, goggles, a helmet, a hat, etc.), support structures 26 may include head-mounted support structures (e.g., a helmet housing, head straps, arms or temples in a pair of eyeglasses, goggle housing structures, and/or other head-mounted structures). A head-mounted support structure may be configured to be worn on a head of a user during operation of device 10 and may support displays 14, sensors 16, other components 24, other input-output devices 22, and control circuitry 12.

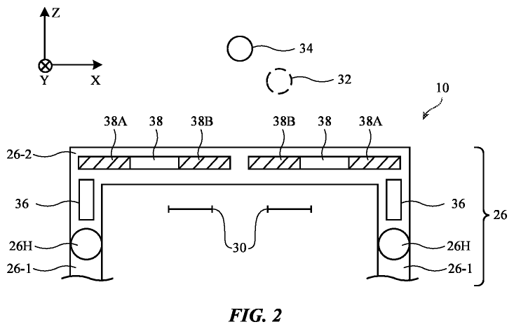

FIG. 2 is a top view of electronic device 10 in an illustrative configuration in which electronic device 10 is a head-mounted device. As shown in FIG. 2, electronic device 10 may include head-mounted support structure 26 to house the components of device 10 and to support device 10 on a user's head. Support structure 26 may include, for example, structures that form housing walls and other structures at the front of device 10 (sometimes referred to as a frame, lens support frame, glasses frame, etc.). In particular, support structure 26 may include support structures 26-2 at the front of device 10, which form glasses frame structures such as a nose bridge, a frame portion that supports left and right lenses with embedded waveguides, and/or other housing structures. Support structure 26 may also include additional structures such as straps, glasses arms, or other supplemental support structures (e.g., support structures 26-1) that help to hold the frame and the components in the frame on a user's face so that the user's eyes are located within eye boxes 30. If desired, support structure 26 may include hinges such as hinges 26H. Support structures 26-1 (which may sometimes be referred to as arms or temples) may be coupled to support structures 26-2 (which may sometimes be referred to as a glasses frame, lens frame, or frame) using hinges 26H (e.g., so that the arms of device 10 can be folded parallel to the frame at the front of device 10 when not in use).

During operation of device 10, images are presented to a user's eyes in eye boxes 30. Eye boxes 30 include a left eye box that receives a left image and a right eye box that receives a right image. Device 10 may include a left display system with a left display 14 that presents the left image to the left eye box and a right display system with a right display 14 that presents the right image to the right eye box. In an illustrative configuration, each display system may have an optical combiner assembly that helps combine display images (e.g., computer-generated image 32 of FIG. 2, sometimes referred to as a virtual image) with real-world image light (e.g., light from real-world objects such as object 34 of FIG. 2). Optical combiner assemblies may include optical couplers, waveguides, and/or other components.

As an example, each display system may have a corresponding projector 36, a waveguide 38, and an optical coupler (e.g., a prism and/or other optical coupling element(s)) to couple an image from the projector into the waveguide from the projector. An output coupler on each waveguide may be used to couple the image out of that waveguide towards a respective eye box after the waveguide has guided the image to a location overlapping the eye box.

In the illustrative configuration of FIG. 2, a left projector 36 may produce a left image and a right projector 36 may produce a right image. Left and right waveguides 38 at the front of device 10 may be provided with left and right optical input couplers 38A that respectively receive the left and right images and couple those images into the left and right waveguides. Waveguides 38 then convey the received images laterally towards the center of device 10 in accordance with the principal of total internal reflection. The left and right images (e.g., computer-generated image 32) are coupled out of the waveguides towards eye boxes 30 using output couplers 38B (e.g., gratings, holographic output couplers, or other suitable output couplers). Output couplers 38B are transparent so that a user may view real-world objects such as object 34 from eye boxes 30.

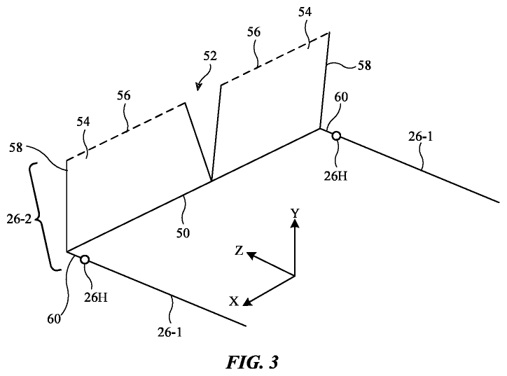

FIG. 3 is a simplified rear perspective view of head-mounted device 10 taken from the underside of device 10. As shown in FIG. 3, support structures 26-1 may be configured to form left and right glasses arms (sometimes referred to as temples or frame supports). The arms of device 10 may be coupled to hinges 26H. When device 10 is being worn on a user's head, the left and right arms of device 10 may extend respectively along the left and right sides of the user's head. Structures 26-2 may include front frame portions such as top frame portion 50 (sometimes referred to as a top frame member, a top frame structure, or an upper frame edge support structure), which extends from left to right laterally across the top of device 10 when device 10 is being worn by a user. Structures 26-2 may also include left and right side frame portions 58 (sometimes referred to as frame edge members or edge support structures) that extend downwards from top frame portion 50 when device 10 is being worn by a user. In the center of device 10, support structures 26-2 may form nose bridge portion 52 (e.g., the glasses frame formed by structures 26-2 may include nose bridge structures that extends downward from top frame member (top frame structure, top frame portion, etc.) 50 on the left and right sides of the user's nose when device 10 is being worn on the head of a user). Portions 60 of structures 26-2, which may sometimes be referred to as glasses frame rearward extensions, side housing extensions, end pieces, or temples, may extend rearwardly to hinges 26H from the glasses frame at the front of device 10 that is formed by portion 50, nose bridge portion 52, and side frame portions 58.

Support structures 26-2 may be configured to support left and right glasses lenses 54. Optional lower frame portions 56 may run along the lower edge of each lens 54 to help support the bottom of lenses 54. Lenses 54 may contain embedded waveguides for laterally transporting images from display projectors to locations that overlap eye boxes 30 (FIG. 2), may contain outer and inner optical elements such as protective transparent layers, vision correction lenses, fixed and/or tunable lenses that help establish a desired virtual image distance for virtual image 32, and/or other optical structures (e.g., light modulator layers, polarizer structures, etc.). In an illustrative configuration, device 10 has a left glasses lens with a left waveguide and output coupler (and, if desired, additional structures such as one or more lens elements with associated optical powers) and a right glasses lens with a right waveguide and right output coupler (and, if desired, additional structures such as one or more lens elements with associated non-zero optical powers). The left waveguide and right waveguide may, as an example, each be sandwiched between outer and inner transparent optical structures (e.g., lens elements, protective transparent layers, etc.). During operation, projectors 36 (FIG. 2) may provide left and right images to the left and right waveguides, respectively. The left and right waveguides may respectively guide the left and right images to portions of lenses 54 with output couplers that overlap eye boxes 30, where the output couplers may direct the left and right images to corresponding left and right eye boxes for viewing by the user's left and right eyes.

During use of device 10, device 10 may be subjected to undesirably larger forces (e.g., during drop events). These excessive forces may cause structures 26 to bend or otherwise deform, which could lead to misalignment between the optical components of device 10. Consider, for example, a scenario in which nose bridge portion 52 of structures 26-2 bends about the Y axis of FIG. 3. In this scenario, the left and right images provided to the left and right eye boxes will diverge (or converge) and will not be satisfactorily aligned with eye boxes 30. As another example, consider a scenario in which nose bridge portion 52 is twisted about the X axis. In this scenario, the left image will be provided above its desired position in the left eye box and the right image will be provided below its desired position in the right eye box (as an example). Deformation of structures 26 may also cause the waveguides in device 10 to become misaligned relative to the projectors in device 10. As these illustrative scenarios demonstrate, deformations of structures 26 due to undesired excessive forces may lead to misalignment and potentials for image distortion (image shifting, keystoning, etc.). These image distortion effects can be compensated for digitally by applying compensating image warping to the image data being supplied to the left and right projectors.

Sensor measurements (e.g., using sensors 16) may be used in measuring deformations to structures 26 and/or other sources of optical system misalignment, so that control circuitry 12 can take corrective action. As an example, frame deformations may be measured using strain gauge circuitry mounted in nose bridge portion 52 and/or other areas of the frame. The strain gauge circuitry may include one or more strain gauges (e.g., one or more sets of strain gauge sensor electrodes that exhibit measurable changes in resistance when bent). The strain gauge circuitry may measure support structure deformation (e.g., frame twisting, frame bending, etc.). In an illustrative scenario, which may sometimes be described herein as an example, the frame of device 10 may have an internal support member such as a metal frame member to which a strain gauge is attached. Bending and/or twisting may be measured about any suitable dimensions (e.g., about axis X, axis Y, and/or axis Z).

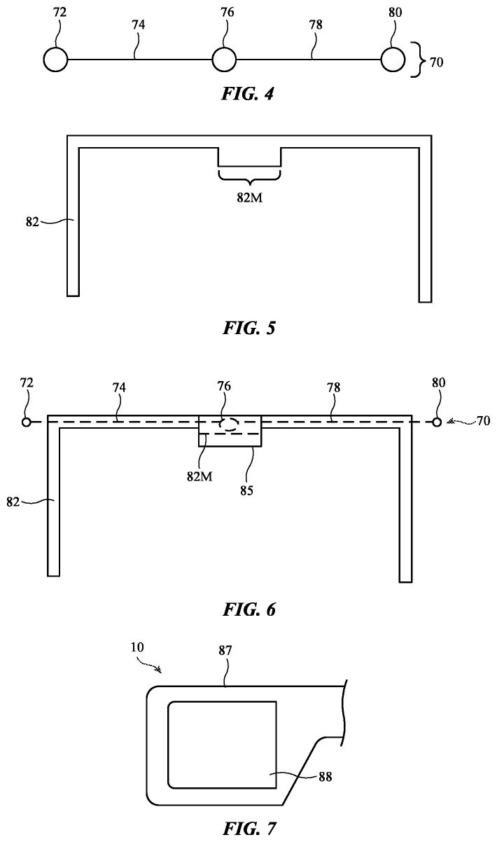

FIG. 4 shows illustrative circuits 72, 76, and 80 for forming the circuitry of device 10 (e.g., control circuitry 12, input-output devices 22, etc.). Circuit 76 may include strain gauge circuitry (sometimes referred to as a strain gauge) such as a strain gauge (strain gauge sensor) formed from strain gauge traces on a flexible printed circuit and associated strain gauge support circuits such as amplifier circuitry (e.g., one or more amplifiers) and analog-to-digital converter circuitry (e.g., one or more analog-to-digital converters) that measure strain-induced resistance changes in the strain gauge traces. The strain gauge may be coupled to a frame member such as a metal frame member to monitor for deformation of the frame member. Circuits 72 and 80 may include integrated circuits and other components for forming control circuitry 12, displays 14 (e.g., projectors 36 of FIG. 2), other input-output devices 22 such as speakers, batteries, etc. Signal paths 74 and 78 (e.g., signal paths formed from wires in cables, metal traces on printed circuits, etc.) may be used in electrically connecting circuits 72, 76, and 80. In this way, power may be routed from batteries in device 10 to integrated circuits, sensors, displays, and other powered components, data from sensors may be routed to control circuitry, control signals and other output may be routed from control circuitry to adjustable components (e.g., displays, actuators, speakers, etc.), etc. The signals carried by paths 74 and 78 may include analog and/or digital signals.

Structures 26 may be configured to form a head-mounted frame with lens openings that receive left and right lenses aligned with a user's eyes. To provide device 10 with desired strength and rigidity, structures 26 (e.g., the head-mounted frame) may include an outer portion such as an outer polymer structure (outer polymer portion) covering one or more inner supporting portions. As an example, structures 26 may include an internal frame member such as frame member 82 of FIG. 5 (sometimes referred to as an inner frame, glasses frame member, internal frame member, stiffening member, etc.). Frame member 82 may be formed from a rigid material such as metal, carbon-fiber composite material or other fiber composites (e.g., polymer containing embedded stiffening fibers of glass, carbon, or other fiber materials), may include a stiff polymer, glass, ceramic, etc. In an illustrative configuration, which may sometimes be described herein as an example, frame member 82 may be formed from metal (e.g., aluminum, titanium, steel, magnesium, and/or other elemental metals and/or metal alloys) and may sometimes be referred to as a metal frame, metal member, or metal frame member. Frame member 82 may be machined (e.g., using a computer numerical control tool or other suitable shaping equipment) and/or may be otherwise shaped into a desired final configuration. In the example of FIG. 5, frame member 82 has a top portion (e.g., an elongated horizontally extending bar that laterally spans the width of the frame of device 10 as described in connection with top portion 50 of FIG. 3). Frame member 82 also has side portions (e.g., internal support member portions used in forming side portions 58 of FIG. 3). Frame member 82 may, if desired, include a central portion 82M with one or more planar surfaces. Portion 82M may, as an example, have a rectangular cross-sectional shape and a thickness that, in at least one dimension, is greater than the corresponding thickness of adjacent end portions of the top portion of frame member 82. When assembled into device 10, central portion 82M may be located in nose bridge portion 52 of structures 26.

FIG. 6 is a front view of frame member 82 following attachment of circuitry 70 of FIG. 4. As shown in FIG. 6, member 82 may have a channel or other structure that receives the cables or other signal lines of paths 74 and 78. The strain gauge of circuit 76 may be mounted to portion 82M. Protective polymer 85 (e.g., epoxy or other polymer) may be molded over circuit 76. The presence of polymer 85 may protect the strain gauge circuitry of circuit 76 from exposure to elevated temperatures during subsequent polymer injection molding operations to form outer portions of the frame.

As shown in the illustrative portion of structures 26 of FIG. 7 (e.g., the head-mounted frame of device 10), polymer injection molding operations may be used to form an external polymer portion of the frame (e.g., polymer frame structures 87 may be molded over frame member 82 and over protective polymer 85 of FIG. 6 to form a glasses frame with a desired outward appearance). The frame (e.g., the polymer of structures 87) may be configured to form lens openings. This allows glasses lenses such as illustrative lens 88 of FIG. 7 to be mounted in frame structures 87 (e.g., left and right lenses 88 may be supported by head-mounted structures 26 formed from frame 82 after overmolding polymer frame structures 87, as described in connection with lenses 54 of FIG. 3). During operation of device 10, projectors may provide left and right images that are guided by waveguides in lenses 54 to respective left and right eye boxes for viewing by a user.

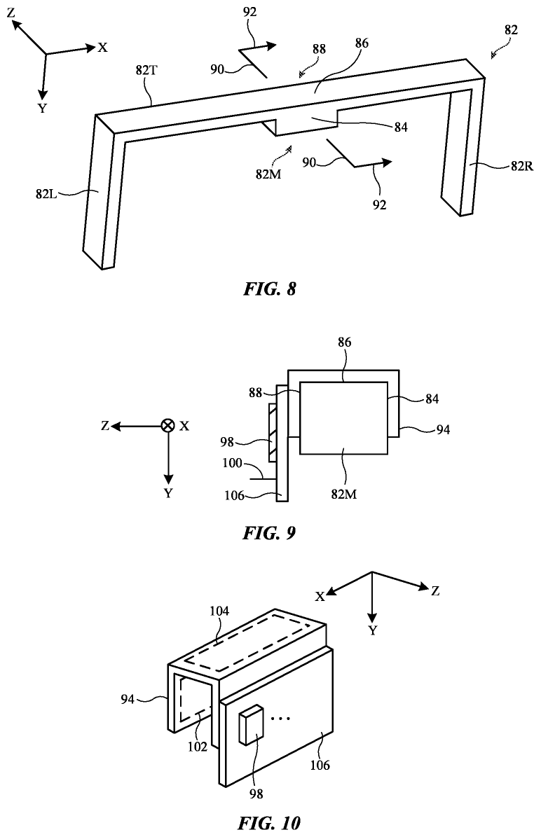

To provide satisfactory support surfaces for the strain gauge mounted to the middle of member 82, central portion 82M of member 82 may be larger in cross-sectional size (e.g., thicker in one or two orthogonal dimensions) than peripheral portions of member 82, as shown in the perspective view of illustrative member 82 of FIG. 8. If desired, strain sensitivity may be enhanced by reducing the thickness of the middle portion. In this type of arrangement, central portion 82M of member 82 may be smaller in cross-sectional size (e.g., thinner in one or two orthogonal dimensions) than peripheral portions of member 82. As shown in FIG. 8, member 82 may, as an example, have a downwardly oriented C-shape with an elongated top portion 82T and left and right side portions 82L and 82R that extend downward from the outer ends of portion 82T, respectively. Portion 82M may have planar surfaces such as planner rear surface 84, opposing planar front surface 88, and upwardly facing top surface 86, which extends between rear surface 84 and front surface 88.

If desired, one or more strain gauges may be mounted to the peripheral portions of member 82 instead of or in addition to mounting a strain gauge to central portion 82M. For example, left and/or right end portions of member 82 may have multiple planar surfaces (e.g., surfaces such as the illustrative planar surfaces of portion 82M) that are configured to receive strain gauge sensor traces). The mounting location for a left strain gauge may, as an example, be to the left of both the right and left lenses), whereas the mounting location for a right strain gauge may, as an example, be located to the right of both the right and left lenses). Strain measurement sensitivity may be enhanced by locally thinning the left and/or right end portions of member 82 under the strain gauge(s) in this type of arrangement. The use of a configuration for member 82 in which a strain gauge is mounted in central portion 82M is illustrative.

The strain gauge of circuit 76 (whether mounted to a central portion and/or to peripheral end portions of member 82) may be formed from conductive traces such as meandering metal traces on a substrate such as a flexible printed circuit substrate. FIG. 9 is a cross-sectional view of portion 82M of member 82 taken along line 90 of FIG. 8 and viewed in direction 92. As shown in FIG. 9, the strain gauge of circuit 76 (FIG. 4) may be formed from strain gauge traces on flexible printed circuit 94 and associated support circuitry. The support circuitry may include one or more integrated circuits such as integrated circuit 98 (e.g., amplifier circuitry, analog-to-digital converter circuitry, etc.). Integrated circuits such as circuit 98 may be mounted directly on flexible printed circuit 94 or may, as shown in FIG. 9, be mounted to a substrate such as substrate 106 (e.g., a rigid printed circuit) that is mounted to flexible printed circuit 94. System-in-package arrangements for circuits 98 may also be used, if desired. Conductive connections between the signal lines in circuits 94 and 106 may be formed using solder, conductive adhesive, connectors, and/or other conductive structures). Signal lines such as lines associated with paths 74 and 78 of FIG. 4 may be attached to the circuitry of FIG. 9 using connections such as connection 100 (e.g., solder pad connections, welds, connectors, etc.).

As shown in the example of FIG. 9, printed circuit 94 may be wrapped at least partly around member 82M. For example, a first planar portion of printed circuit 94 may be attached to inner planer surface 84, a second planar portion of printed circuit 94 may be attached to outer planar portion 88, and a third planar portion of printed circuit 94, which extends between the first and second portions, is attached to top planar surface 86. As shown in FIG. 10, the portion of printed circuit 94 that overlaps surface 84 may contain a first set of strain gauge traces 102 and the portion of printed circuit 94 that overlaps surface 86 (which has a surface normal that is orthogonal to the surface normal of surface 84) may contain a second set of strain gauge traces 104. Traces 102 and 104 may each contain, for example, a set of individual patches of strain gauge traces coupled to respective arms of a Wheatstone bridge circuit or other strain gauge circuitry. Using traces 102 and 104, bending about orthogonal axes Y and Z may be measured, torsional deformation (e.g., twisting of member 82 about the X axis of FIG. 10) may be measured, and/or other deformation of member 82 and therefore head-mounted support structure 26 may be measured. Control circuitry 12 may process these measurements of the deformation of the support structures of device 10 and may take appropriate corrective action (e.g., by warping image data supplied to the left and right display projectors to compensate for any measured deformation, by adjusting optical component alignment positioners, etc.). In the example of FIG. 9, the first and second sets of strain gauge traces 102 are formed on separate portions of the same printed circuit 94 (e.g., the printed circuit wrapped around member 82M). If desired, separate strain gauge substrates may be used (e.g., a first printed circuit may contain the first set of strain gauge traces, a second printed circuit may contain the second set of strain gauge traces, and each of these sets of strain gauge traces may be mounted on a respective planar surface of member 82M). With this approach, a first portion of the strain gauge may be formed from a first strain gauge printed circuit on a first planar surface of the central portion of the metal frame member and a second portion of the strain gauge may be formed from a second strain gauge printed circuit on a second planar surface of the central portion of the metal frame member. The first and second planar surfaces may have respective first and second surface normals that are perpendicular to each other.

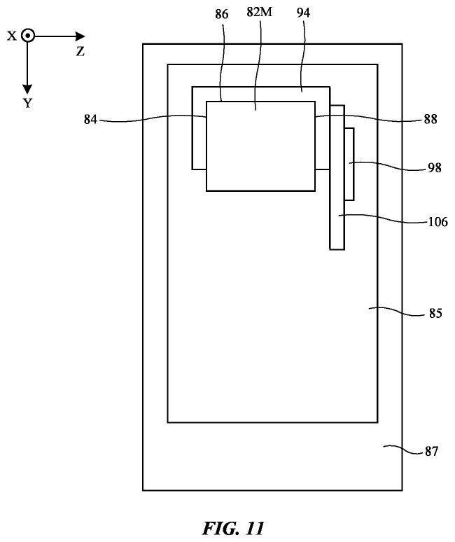

FIG. 11 is a cross-sectional side view of a top portion of the head-mounted frame formed from structures 26 (e.g., a cross-sectional side view of member 82 taken along line 90 of FIG. 8 following overmolding of polymer frame structures on top of frame member 82). As shown in FIG. 11, the strain gauge formed from flexible printed circuit substrate 94 and circuit(s) 98 on printed circuit 106 may be embedded within a protective inner structure such as a structure formed from protective polymer 85. Additional polymer may be formed around polymer 85. For example, outer frame structures such as polymer structures 87 (see, e.g., FIG. 7) may be injection molded (using one or more polymer injection molding shots) around polymer 85 and exposed portions of frame member 82. The presence of polymer 85 may prevent polymer structures 87 from contacting the strain gauge circuitry (circuit 76) and thereby may protect the strain gauge from elevated injection molding temperatures involved in forming structures 87. Structures 87 may be configured to form a glasses frame with a desired shape and appearance (e.g., a shape for supporting lenses such as lens 88 of FIG. 7, a desired shape for forming nose bridge portion 52 of structures 26, etc.). Circuits 72 and 80 may be mounted in interior cavities of structures 26 (e.g., cavities in portions 60 of molded polymer structures 87) or elsewhere in structures 26.

In some embodiments, sensors may gather personal user information. To ensure that the privacy of users is preserved, all applicable privacy regulations should be met or exceeded and best practices for handling of personal user information should be followed. Users may be permitted to control the use of their personal information in accordance with their preferences.

In accordance with an embodiment, a head-mounted device is provided that includes a head-mounted frame with a metal frame that extends laterally across the head-mounted frame, left and right projectors configured to output respective left and right images, left and right lenses in the head-mounted frame, and a strain gauge having a flexible printed circuit coupled to the metal frame between the left and right lenses, the flexible printed circuit having a first portion with first strain gauge traces and a second portion with second strain gauge traces.

In accordance with another embodiment, the metal frame has first and second planar surfaces and the first portion is attached to the first planar surface and the second portion is attached to the second planar surface.

In accordance with another embodiment, the first planar surface and second planar surface have respective surface normals that are orthogonal to each other.

In accordance with another embodiment, the first planar surface extends across an upwardly facing portion of the metal frame and the second planar surface extends across a horizontally facing portion of the metal frame.

In accordance with another embodiment, the metal frame includes a C-shaped metal frame having a top portion that extends across the head-mounted frame over the left and right lenses and has left and right side portions that extend downwardly from respective left and right ends of the top portion and the strain gauge is attached to the top portion.

In accordance with another embodiment, the head-mounted frame includes polymer covering at least part of the metal frame.

In accordance with another embodiment, the top portion includes a metal bar with a central portion that has a rectangular cross-sectional profile and the strain gauge is attached to the central portion.

In accordance with another embodiment, the central portion has first and second planar portions and the flexible printed circuit is bent around the central portion and attached to the first and second planar portions.

In accordance with another embodiment, the first and second planar portions are oriented perpendicular to each other.

In accordance with another embodiment, the metal bar has first and second end portions, the central portion is between the first and second end portions, and the central portion is thicker in at least one cross-sectional dimension than the first and second end portions.

In accordance with another embodiment, the metal bar has first and second end portions, the central portion is between the first and second end portions, and the central portion is thinner in at least one cross-sectional dimension than the first and second end portions.

In accordance with another embodiment, the metal frame includes a metal bar and the flexible printed circuit is attached to the metal bar and is configured to measure deformation of the metal bar.

In accordance with another embodiment, the strain gauge is configured to measure deformation of the metal frame, the head-mounted frame includes a first polymer portion that covers the strain gauge and a second polymer portion molded over at least part of the metal frame and over the first polymer portion.

In accordance with another embodiment, the flexible printed circuit is embedded in the first polymer portion and the first polymer portion prevents contact between the flexible printed circuit and the second polymer portion.

In accordance with another embodiment, the first polymer portion is embedded within the second polymer portion and the second polymer portion has lens openings configured to receive the left and right lenses, respectively.

In accordance with another embodiment, the left and right lenses include respective left and right waveguides that guide the left and right images.

In accordance with an embodiment, a head-mounted device is provided that includes a metal frame, a strain gauge having a flexible printed circuit with strain gauge traces, the flexible printed circuit is wrapped at least partly around a central portion of the metal frame, polymer attached to the metal frame, the polymer has lens openings, and lenses in the lens openings.

In accordance with another embodiment, the head-mounted device includes at least one projector that provides an image, at least one of the lenses has a waveguide that guides the image.

In accordance with another embodiment, the strain gauge includes an amplifier and an analog-to-digital converter mounted on a substrate that is attached to the flexible printed circuit.

In accordance with an embodiment, a head-mounted device is provided that includes a metal frame having first and second planar surfaces with respective first and second surface normals that are perpendicular to each other, a strain gauge having a first printed circuit with first strain gauge traces that is mounted on the first planar surface and having a second printed circuit with second strain gauge traces that is mounted on the second planar surface, polymer attached to the metal frame, the polymer has lens openings, and lenses in the lens openings.

In accordance with another embodiment, the head-mounted device includes at least one projector that provides an image, at least one of the lenses has a waveguide that guides the image.

In accordance with another embodiment, the strain gauge includes an amplifier and an analog-to-digital converter.

In accordance with an embodiment, a head-mounted device is provided that includes a head-mounted frame having an elongated metal internal frame that extends laterally across the head-mounted frame and having a polymer frame portion that covers the elongated metal internal frame, the polymer frame portion has lens openings, lenses in the lens openings, and a strain gauge having a flexible substrate that is attached to the elongated metal internal frame.

In accordance with another embodiment, the elongated metal internal frame has a central portion with at least first and second planar surfaces oriented in different directions and the flexible substrate is attached to the first and second planar surfaces.

The foregoing is merely illustrative and various modifications can be made to the described embodiments. The foregoing embodiments may be implemented individually or in any combination.

What is claimed is:

1. A head-mounted device, comprising:
a head-mounted frame with a metal frame that extends laterally across the head-mounted frame;
left and right projectors configured to output respective left and right images;
left and right lenses in the head-mounted frame; and
a strain gauge having a flexible printed circuit coupled to the metal frame between the left and right lenses, the flexible printed circuit having a first portion with first strain gauge traces and a second portion with second strain gauge traces.

2. The head-mounted device defined in claim 1 wherein the metal frame has first and second planar surfaces and wherein the first portion is attached to the first planar surface and the second portion is attached to the second planar surface.

3. The head-mounted device defined in claim 2 wherein the first planar surface and second planar surface have respective surface normals that are orthogonal to each other.

4. The head-mounted device defined in claim 3 wherein the first planar surface extends across an upwardly facing portion of the metal frame and wherein the second planar surface extends across a horizontally facing portion of the metal frame.

5. The head-mounted device defined in claim 1 wherein the metal frame comprises a C-shaped metal frame having a top portion that extends across the head-mounted frame over the left and right lenses and has left and right side portions that extend downwardly from respective left and right ends of the top portion and wherein the strain gauge is attached to the top portion.

6. The head-mounted device defined in claim 5 wherein the head-mounted frame comprises polymer covering at least part of the metal frame.

7. The head-mounted device defined in claim 6 wherein the top portion comprises a metal bar with a central portion that has a rectangular cross-sectional profile and wherein the strain gauge is attached to the central portion.

8. The head-mounted device defined in claim 7 wherein the central portion has first and second planar portions and wherein the flexible printed circuit is bent around the central portion and attached to the first and second planar portions.

9. The head-mounted device defined in claim 8 wherein the first and second planar portions are oriented perpendicular to each other.

10. The head-mounted device defined in claim 9 wherein the metal bar has first and second end portions, wherein the central portion is between the first and second end portions, and wherein the central portion is thicker in at least one cross-sectional dimension than the first and second end portions.

11. The head-mounted device defined in claim 9 wherein the metal bar has first and second end portions, wherein the central portion is between the first and second end portions, and wherein the central portion is thinner in at least one cross-sectional dimension than the first and second end portions.

12. The head-mounted device defined in claim 1 wherein the metal frame comprises a metal bar and wherein the flexible printed circuit is attached to the metal bar and is configured to measure deformation of the metal bar.

13. The head-mounted device defined in claim 1 wherein the strain gauge is configured to measure deformation of the metal frame, the head-mounted frame further comprising a first polymer portion that covers the strain gauge and a second polymer portion molded over at least part of the metal frame and over the first polymer portion.

14. The head-mounted device defined in claim 13 wherein the flexible printed circuit is embedded in the first polymer portion and wherein the first polymer portion prevents contact between the flexible printed circuit and the second polymer portion.

15. The head-mounted device defined in claim 14 wherein the first polymer portion is embedded within the second polymer portion and wherein the second polymer portion has lens openings configured to receive the left and right lenses, respectively.

16. The head-mounted device defined in claim 15 wherein the left and right lenses comprise respective left and right waveguides that guide the left and right images.

17. A head-mounted device, comprising:
a metal frame;
a strain gauge having a flexible printed circuit with strain gauge traces, wherein the flexible printed circuit is wrapped at least partly around a central portion of the metal frame;
polymer attached to the metal frame, wherein the polymer has lens openings; and
lenses in the lens openings.

18. The head-mounted device defined in claim 17 further comprising at least one projector that provides an image, wherein at least one of the lenses has a waveguide that guides the image.

19. The head-mounted device defined in claim 17 wherein the strain gauge comprises an amplifier and an analog-to-digital converter mounted on a substrate that is attached to the flexible printed circuit.

20. A head-mounted device, comprising:
a metal frame having first and second planar surfaces with respective first and second surface normals that are perpendicular to each other;
a strain gauge having a first printed circuit with first strain gauge traces that is mounted on the first planar surface and having a second printed circuit with second strain gauge traces that is mounted on the second planar surface;
polymer attached to the metal frame, wherein the polymer has lens openings; and
lenses in the lens openings.

21. The head-mounted device defined in claim 20 further comprising at least one projector that provides an image, wherein at least one of the lenses has a waveguide that guides the image.

22. The head-mounted device defined in claim 20 wherein the strain gauge comprises an amplifier and an analog-to-digital converter.

23. A head-mounted device, comprising:
a head-mounted frame having an elongated metal internal frame that extends laterally across the head-mounted frame and having a polymer frame portion that covers the elongated metal internal frame, wherein the polymer frame portion has lens openings;
lenses in the lens openings; and
a strain gauge having a flexible substrate that is attached to the elongated metal internal frame.

24. The head-mounted device defined in claim 23 wherein the elongated metal internal frame has a central portion with at least first and second planar surfaces oriented in different directions and wherein the flexible substrate is attached to the first and second planar surfaces.
